(19) United States
(12) Patent Application Publication
(10) Pub. No.: US 2012/0078901 A1
(43) Pub. Date: Mar. 29, 2012

(54) Personal Genome Indexer

(76) Inventor: Jorge Conde, Cambridge, MA (US)

(21) Appl. No.: 13/222,475

(22) Filed: Aug. 31, 2011

Related U.S. Application Data
(60) Provisional application No. 61/379,178, filed on Sep. 1, 2010.
(60) Provisional application No. 61/378,497, filed on Aug. 31, 2010.

(51) Int. Cl. G06F 17/30

(52) U.S. Cl. 707/736; 707/E17.002

(57) ABSTRACT

The present invention relates to method and computer systems that provide a personal genome indexer. The present invention provides an output that allows individuals to access publically available scientific resources through the “prism” of their unique genetic code. Individual genetic information is indexed with information from public databases (e.g., PubMed database) that contain genetic information about the condition and the risk allele, and public databases (e.g., MedLinePlus database) that provide information about the condition. In an aspect, the present invention provides an output display that correlates an individual's specific risk alleles with genetic information and associated phenotypic condition based on one or more references from a publically accessible database, and/or a link to consumer health information about the phenotypic condition.

### RELATED APPLICATIONS

This application claims the benefit of U.S. Provisional Application No. 61/379,178 filed Sep. 1, 2010 entitled, “Personal Genome Indexer” by Jorge Conde; and claims the benefit of U.S. Provisional Application No. 61/378,497 filed Aug. 31, 2010 entitled, “Personal Genome Indexer” by Jorge Conde.

The entire teachings of the above application(s) are incorporated herein by reference.

### BACKGROUND OF THE INVENTION

The U.S. government, though agencies like the National Institutes of Health (NIH) and others, has long been an active supporter of biomedical research by providing grants and other sources of funding for scientists, clinicians and other researchers. In fact, external research funding accounts for approximately 83% of the NIH's $30 billion budget, with the National Human Genome Research Institute (NHGRI) acting as a driver to apply genome technologies to the study of specific diseases. Over the last decade, the number of genome wide association studies (GWAS) and other research aiming to elucidate links between diseases and specific genetic variation (also known as variants, or mutations) have yielded exponential growth in our collective knowledge of how our genomes may contribute to the predisposition of developing certain conditions or diseases. Findings from such studies and researches are commonly reported and stored in various public or commercial databases. For example, the NIH funded researches are generally published in scientific journals, most of which are made available to the general public through PubMed, a free, publicly-accessible database maintained by the U.S. National Library of Medicine and the NIH.

A direct result of the genome revolution is that the technologies used to sequence and “read” genome data have improved dramatically, obtaining incredibly rich data sets. The advance in the sequencing technology has also caused a significant drop in the cost of sequencing a human genome. As costs continue to fall, this technology will become increasingly accessible to the general population. Many people have expressed interest in learning about what their genetic information might tell them about themselves. As a source of information, the genome is an incredibly rich data source and it can provide a wide range of information from ancestry and traits, to the risk of developing a disease or passing it along to future generations.

In addition to funding genetic research, the NIH has also spent considerable time and money establishing resources for public education like MedLinePlus (“Trusted Health Information for You”), a service provided jointly with the U.S. National Library of Medicine. According to the website, MedLine “brings you information about diseases, conditions, and wellness issues in language you can understand. MedlinePlus offers reliable, up-to-date health information, anytime, anywhere, for free.” While PubMed and MedLine are rich sources of scientific and health information, they are not easily accessible to the general public unless an individual knows to search for a specific topic of interest. On the other hand, the information contained within a human genome is an undecipherable code to the average individual, a string of 3 billion “letters” of code written in As, Cs, Ts and Gs.

A pressing challenge that has arisen as a result of the advances in genome technologies relates to the impact this information might have on individuals. Although individuals may have access to information about their own genomes, a need exists to determine how this information should be presented to ensure that it is clear, transparent and from a trustworthy source. A further need exists to present information about an individual's DNA in the context of publically available databases in a user friendly fashion.

### SUMMARY OF THE INVENTION

The present invention relates to methods of providing a personal genomics indexer having individual genomic information, genotypic and phenotypic information based on scientific research, and consumer health information. An individual's genomic information includes a digital genome and variant call list having one or more variants. The steps of the method includes comparing (e.g, with a processor) the one or more variants from the variant call list from the individual's genomic information to datapoints from a database, wherein the datapoints of the database include one or more variant information associated with a phenotypic condition reported in a research paper or journal article, the phenotypic condition, a relative odds measure or statistical risk associated with the variant, and an identifier of the journal article; to thereby obtain a variant match and a phenotypic condition associated with the match. The method also includes comparing the phenotypic condition associated with the match with one or more phenotypic conditions in a consumer health information database, wherein the consumer health information database has information or a link to information about the phenotypic condition; to thereby obtain a joined dataset. The joined dataset has the individual's digital genome, the variant match, the phenotypic condition associated with the match, the identifier of the journal article, the information or link to information about the phenotypic condition in the consumer health information database, and optionally any additional relevant information. The method can further include providing an output that provides data from the joined dataset that has the individual's digital genome, the variant match, the phenotypic condition associated with the match, the identifier of the journal article, and the link to information about the phenotypic condition in the consumer health information database. In an embodiment, the output further includes the genetic variant of the individual, the chromosomal position of the variant in the individual, the genotype of the variant of the individual, the match, a gene name associated with the match, the phenotypic conditions associated with the match, the statistical risk reported in the journal article, the identifier of the journal article, and the link to information about the phenotypic condition in the consumer health information database. In an aspect, the output is represented in table form or graphically. The database embodies data from a publically available database, such as the PubMed database. In an embodiment, the consumer health information database comprises links to information about the phenotypic condition in a publically available database (e.g., the MedLinePlus database). The individual's variant call list, in one aspect, is obtained by comparing the individual's digital genome to a reference genome.

The present invention further embodies methods of providing an output of a personal genomics indexer having individual genomic information, genotypic and phenotypic information based on scientific research, and consumer health information. The steps of the method include obtaining the individual's genomic information that has a digital genome and variant call list; and comparing the variant call list from the individual's genomic information to datapoints from a structured database, wherein the datapoints of the structured database comprise a variant associated with a phenotypic condition reported in a journal article, the phenotypic condition, a gene name associated with the variant, a statistical risk associated with the variant, and an identifier of the journal article; to thereby obtain a variant match and a phenotypic condition associated with the match. The methods can optionally include comparing the phenotypic condition associated with the match with one or more phenotypic conditions in a consumer health information database, wherein the consumer health information database comprises a link to information about the phenotypic condition; to thereby obtain a joined dataset. The joined data set includes the following information e.g., the individual's digital genome, the genetic variant of the individual, the chromosomal position of the variant in the individual, the genotype of the variant of the individual, the match, a gene name associated with the match, the phenotypic condition associated with the match, the statistical risk reported in the journal article, the identifier of the journal article, and the link to information about the phenotypic condition in the consumer health information database. The steps of the method can further include providing an output that has data from the joined dataset.

Yet, in another embodiment, the present invention pertains to methods of providing an output of a personal genomics indexer having individual genomic information, genotypic and phenotypic information based on scientific research, and consumer health information. The steps of the method include receiving the individual's genomic information that has a digital genome and variant call list comprising one or more variants, and comparing with a processor, the variant call list from the individual's genomic information to datapoints from a structured database (e.g., a publically available database), wherein the datapoints of the database include a variant associated with a phenotypic condition reported in a journal article, the phenotypic condition, a gene name associated with the variant, a statistical risk associated with the variant, and an identifier of the journal article; to thereby obtain a variant match and a phenotypic condition associated with the match. The steps further include comparing, with a processor, the phenotypic condition associated with the match with one or more phenotypic conditions in a consumer health information database (e.g., a publically available database), wherein the consumer health information database includes a link to information about the phenotypic condition; to thereby obtain a joined dataset comprising the individual's digital genome, the genetic variant of the individual, the chromosomal position of the variant in the individual, the genotype of the variant of the individual, the match, a gene name associated with the match, the phenotypic condition associated with the match, the statistical risk reported in the journal article, the identifier of the journal article, and the link to information about the phenotypic condition in the consumer health information database. The method also involves providing an output (e.g., in table form or graphically) that comprises data from the joined dataset. In an aspect, the individual's variant call list is obtained by comparing the individual's digital genome to a reference genome.

The present invention also relates to a computer apparatus or computer system for providing a personal genomics indexer having individual genomic information, genotypic and phenotypic information based on scientific research, and consumer health information. The apparatus has a first source of an individual's genomic information including a digital genome and variant call list; and a second source from a structured database, wherein the datapoints of the structured database comprise a genetic variant associated with a phenotypic condition reported in a journal article, the phenotypic condition, a statistical risk associated with the variant, and an identifier of the journal article. The apparatus also includes a first processor routine coupled to receive the individual's genomic information from the first source and datapoints of the structured database from the second source, the processor routine utilized to compare the variant call list to genetic variants associated with a phenotypic condition reported in a journal article, to obtain a variant match and a phenotypic condition associated with the match; and a second processor routine coupled to receive the variant match and the phenotypic condition associated with the match, the second processor routine utilized to link the phenotypic condition associated with the match with one or more phenotypic conditions in a consumer health information database, wherein the consumer health information database comprises a link to information about the phenotypic condition; to thereby obtain a joined dataset comprising the individual's digital genome, the variant match, the phenotypic condition associated with the match, the identifier of the journal article, and the link to information about the phenotypic condition in the consumer health information database. In an embodiment, the computer apparatus also includes an output device that has a display of data from the joined dataset that comprises the individual's digital genome, the variant match, the phenotypic condition associated with the match, the identifier of the journal article, and the link to information about the phenotypic condition in the consumer health information database. The display can further include the genetic variant of the individual, the chromosomal position of the variant in the individual, the genotype of the variant of the individual, the match, a gene name associated with the match, the phenotypic conditions associated with the match, the statistical risk reported in the journal article, the identifier of the journal article, and the link to information about the phenotypic condition in the consumer health information database.

In yet another embodiment, the present invention relates to a system for providing personal genomic indexed information. The system includes a processor for comparing a personal genome data comprising a digital genome and variant call list having one or more genetic variants, a genotype-phenotype association data having one or more variant information associated with a phenotypic condition reported in a research paper or a journal article, a phenotype data including information or links to information about one or more phenotypic conditions in a consumer health information database, and an indexed data. The system further includes storage for storing the personal genome data, the genotype-phenotype association data, the phenotype data, and the indexed data; and a network for managing communication between a plurality of networked components including the processor and storage. The computer system embodies an output device for presenting the indexed data to a user. In an aspect, the storage is contained in a centralized server for storing and retrieving data via network. The system, in an aspect, also has one or more of interface modules for connecting one or more removable storage devices. The output can be a remote user terminal connected via the network, and can be implemented as software in a browser tool.

The present invention advantageously allows individual's genomic information to be presented in the context of publicly available resources or databases. In certain cases, it provides an additional use for publically funded resources and databases. More importantly, the Personal Genome Indexer of the present invention is not making an arbitrary or “black-box” assessment of an individual's risk of developing a specific disease. Rather, it is providing information that a specific variant was found to have a statistical risk based on a reported study. Hence, the present invention provides information about an individual's genetic make-up without bias or conclusion, and based on published scientific information.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic showing the Personal Genome Indexer 100 in which a digital representation of an individual's genome is obtained after being sequenced, using a next-generation sequencing platform or similar, (Step A), and compared to reference genetic information to obtain dataset B containing a digital genome and a list of variants (e.g. positional genomic information, the variant name, and the genotype), as compared to the reference genome. The Figure also shows the publically available PubMed database, database C, and structured database D which stores relevant and specific information from database C, including the genetic variant, the gene name, the associated phenotype, the range of estimated relative odds (e.g., odds ratios) and the PubMed ID numbers that have studied the potential association between a specific genetic variant and a specific phenotype (e.g. a disease, trait or condition). The data from database D is compared with the variant list from dataset B to obtain filtered hits stored in database E. Database F, information from the MedLine Plus database, is used to provide an annotated record that ties phenotypic information from the MedLinePlus database to the filtered hits of database E, to thereby obtain joined database G. Joined database G has linked data from the individual's genome, the PubMed structured database and links to associated phenotypic information in the MedLine Plus database. Browsing tool H provides the output of joined database G.

FIG. 2 is a table of data of joined database G showing individual genome data (e.g., position, variant, genotype), published genotype-phenotype associated via PubMed (e.g., Genetic risk variant match, gene name, phenotype name, relative odds measure (odds ratio), PubMed ID number), and health information research (e.g., link to disease or phenotypic condition).

FIG. 3 is a flowchart showing steps of the methods of an embodiment of the present invention providing indexed genetic information.

FIG. 4 is a block diagram showing a personal genome indexer computer system and components thereof.

FIG. 5A is a screen output of the “home screen” from the personal genome indexer of the present invention.

FIG. 5B is a screen output of data from the personal genome indexer of the present invention, providing a graphical display of indexed genomic information. The graphical representation shows the chromosomes, variant alleles, their position, associated phenotypic information from a research database or journal article and the risk associated with the variant.

FIG. 5C is a screen output of data from FIG. 5B with the user “mousing” over the variant, and the variant and the associated phenotype (e.g., coronary artery disease) is displayed.

FIG. 5D is screen output of the chromosome view of the personal genome indexer of the present invention showing the list of variants associated with the chromosome.

FIG. 5E is a screen output of consumer-friendly content of the personal genome indexer of the present invention, and such information can imported from public sources like MedLine or just include direct links out to the relevant information.

FIG. 5F is a screen output of a variant analysis view of the personal genome indexer of the present invention showing a list of variants for the individual.

FIG. 5G is a screen output of information showing information from a research/journal database having variant specific information about a phenotype. Note that the abstract number in the browser's address bar matches the number in the first row under the “publications” column in FIG. 5F (#: 20149326).

### DETAILED DESCRIPTION OF THE INVENTION

A description of preferred embodiments of the invention follows.

The present invention relates to new methods and systems for a personal genome indexer to provide an output that allows individuals to access resources like PubMed and MedLine through the “prism” of their unique genetic code. In particular, the present invention relates to methods and systems for indexing individual genetic information including risks reported for an associated condition. “Indexing” refers to relating information from one or more databases based on a comparison, in this case a comparison of variant genomic information reported to be associated with a phenotypic condition. In embodiment, individual genetic information is indexed with information from public databases (e.g., PubMed database) that contain genetic information about the condition and the risk allele/variant, and public databases (e.g., MedLinePlus database) that provide information about the condition. In an aspect, the present invention provides an output that correlates an individual's specific risk alleles with one or more references from the PubMed database, and one or more references from the MedLinePlus database.

As an analogy, the present invention is similar to using an Internet search engine, but instead of typing a topic of interest into the search bar to see search results, the individual's genome data acts as the search topic and only relevant records specific to the individual's unique genome are displayed.

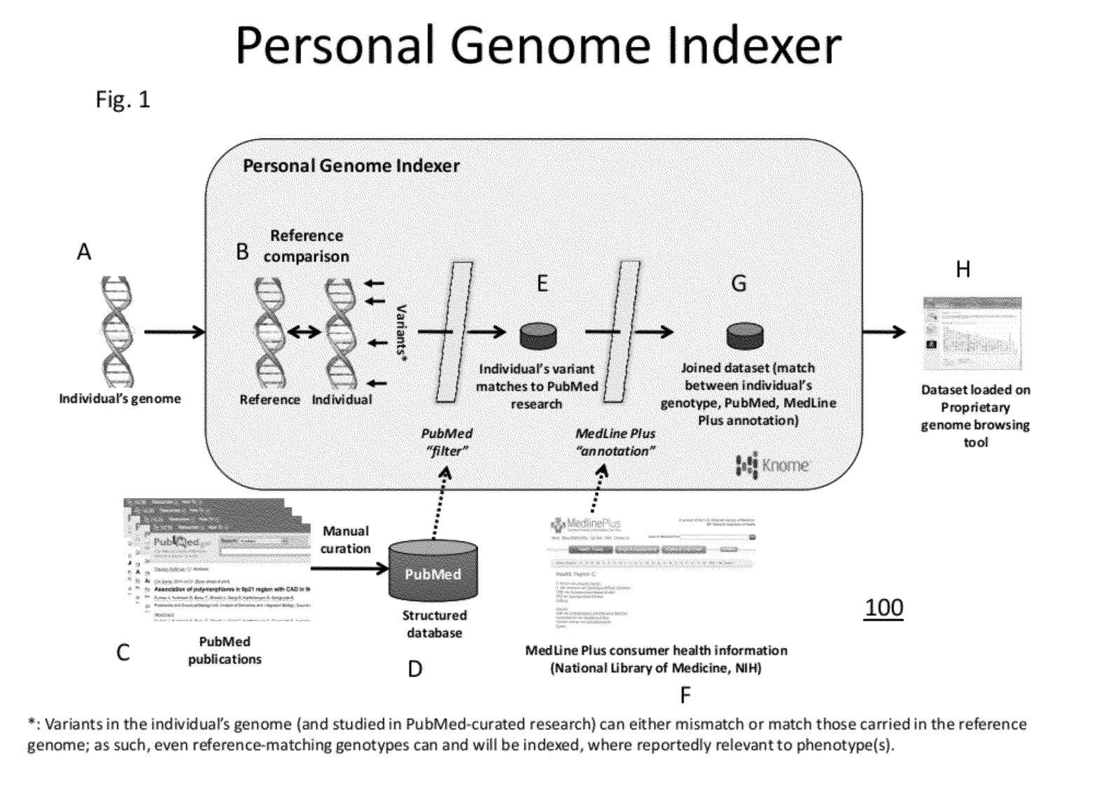

Referring to FIG. 1, personal genome indexing system 100 is shown. Information for personal genome indexing system 100 includes, in part, an individual's genetic information. To obtain an individual's genetic information, a sample (e.g., blood, saliva, semen, serum, urine and other cellular material) containing deoxyribonucleic acid (DNA) is taken from the individual. DNA is genetic information that is stored as a code made up of four chemical bases: adenine (A), guanine (G), cytosine (C), and thymine (T). Generally, human DNA consists of about 3 billion bases, and more than 99 percent of those bases are the same in all people. The sample is prepared and the DNA is extracted from the cells and processed, according to commercially acceptable protocols. Sequencing can be done by a laboratory using next-generation sequencing platform. Step A, FIG. 1. Examples of genomic sequencers include the 454 Genome Sequencer FLX (454 Life Sciences/Roche Applied Science, Branford, Conn., USA), the Illumina Genome Analyzer, powered by Solexa® (Illumina, Inc San Diego, Calif., USA) and the SOLiD™ system (Applied Biosystems by Life Tecnologies, Carlsbad, Calif. USA), HeliScope™ single molecule sequencer (Helicos BioSciences Corporation Cambridge, Mass. USA) and CEQ™ 8000 (Beckman Coulter, Inc. Brea, Calif. USA). Sequencing techniques known in the art or later developed can be used with the methods and systems of the present invention. To increase the rate at which the DNA is sequenced, the DNA is digested and sequenced in smaller pieces and then reassembled.

The sequencers provide a digital genome. The digital genome is a reasonable and accurate representation of the individual's DNA. Laboratories that sequence the DNA can be Clinical Laboratory Improvement Amendments (CLIA) certified. Sequence analysis is often performed with redundancy and overlap to ensure accuracy (e.g., sequencing the DNA more than once and sequencing overlapping sections of the DNA and verifying the sequence). The sequenced information is then aligned and assembled. The sequenced genome is assembled using computer algorithms, resulting in a “digital” representation of the genome.

In addition to a digital genome, the digital genome is compared to a reference genome (e.g. the Reference Human Genome, NCBI Build 36, www.ncbi.nlm.nih.gov/projects/genome/assembly/grc/human/index.shtml) and the differences between the reference genome and an individual's genome are recorded in a database. See Dataset B, FIG. 1. In an embodiment, the digital genome is compared to a reference genome, and the variant matches and variant mismatches between the reference genome and individual's genome are recorded. In the case in which the reference genome is not known to have a variant, then the mismatch or difference is recorded in the call list as a variant. In the case in which the reference genome known to have a variant, and the digital genome matches the variant gene of the reference genome, then this variant is also recorded in the call list as a variant. The variants are referred to as a “call list” of variant alleles present in the individual's digital genome. The variant alleles may or may not be associated with a disease or condition. Dataset B shown in FIG. 1 includes the digital genome sequence and a call list of variants. Dataset B, provided on a storage medium or to the network that processes in the information, as further described herein, is used in Personal Genome Indexer 100.

The PubMed static database C is a collection of scientific information that includes journal references, genetic information, disease, condition or symptom associated with genetic information, and other information. The link to the searchable PubMed database is http://www.ncbi.nlm.nih.gov/pubmed. The PubMed database is an example of an online database. Any database having genetic information and journal references that describe genetic variant information associated with a condition or phenotype can be used, including those later developed. Using information from the database C, a dynamic and structured database, database D, is created and contains extracted, relevant datapoints. In an embodiment, papers are interpreted, and relevant data is recorded or entered (e.g., phenotype studies and characteristics including diseases, conditions, or symptoms; genetic information including genetic positional information and genetic variants; statistical information including incidence, population type, associated statistical risk, PubMed logistical information including PubMed ID and link, etc.) in database D using a standardized data format. Alternatively, database C is queried for certain information and the relevant datapoints are saved in structured database D. Any relevant genotypic and associated phenotypic information can be included in database D.

As used herein, a “database” is a collection of two or more pieces of stored data or datapoints. As used herein the term “information” can be interchangeable, where suitable, with the term “datapoint”. Data can be stored in a manner, and in a mode known in the art, or developed in the future. Examples of types of databases that store data and links described herein include MY SQL, SQL, and Oracle. The data can be stored physically together, or associated with one another.

Quality control is performed on structured database D to ensure its accuracy. To minimize the potential for misinterpretations of the scientific research in the unstructured database C, or incorrect data placed into database D, random data sampling is performed to ensure quality. Database inputs are also matched back to original PubMed research of database C. A data entry tool, in an embodiment, is used to minimize and assist the user to minimize this error. Any deviations can be recorded and improvements to process would be made as needed.

The present invention involves matching or correlating the individual's genomic data of database B to the dynamic and structured PubMed data of database D. Using a computer processor and processor routine, the data is processed to produce a filtered list or “hits” in which the individual's genetic variant is matched to a genetic variant that has appeared in the scientific literature e.g., via PubMed. Specifically, genetic variants associated with a disease, condition, symptom or other phenotype from database D is compared against the individual variant call list of database B, and a filtered list of hits is produced. The comparison can include a determination of the existence of a variation at a particular nucleic acid position that has been researched for an association to a specific phenotype (i.e. disease, condition or trait). In the case in which there is a match for a variant at a specific position, the software can generate a filtered dataset E with these hits.

The matching can also include a comparison of the specific nucleic acid residues (e.g., ATCGs) at that position (e.g., a determination if that specific nucleic acid variation at that position is the same or if they differ, what the difference is). For example, there is a genetic variant reported in the literature in the PubMed database at chromosome 16, position 81769899 and the paper in the database reports an associated increased incidence with heart disease. Database B, for example, could indicate that the individual has a “G” and a “T” at that position (one inherited from each biological parent), whereas Database D indicates that the “G” variant at that position was associated with increased risk for heart disease. The reference DNA could indicate that the nucleic acid residue at that position is a “T”. In cases where the individual's genotype at a specific position does not contain the risk variant found in the literature, the filtered data could report that the variant associated with increased risk has been reported at that particular location, but the individual's genotype does not contain the risk variant. Alternatively, the software application could be set to report only instances where the individual's genotype matches a risk variant as identified in the scientific literature. In an aspect, the present invention relates to matching the chromosome and position of the variant, matching the specific nucleic acid variant or Single Nucleotide Polymorphism (SNP), or both. The data from this matching step is referred to herein as “dataset E” in FIG. 1 and is stored in a database. Potential errors in pattern matching between the two data sets can be minimized by using unique identifiers for a variant (RS# and/or positional data) and/or random data sampling.

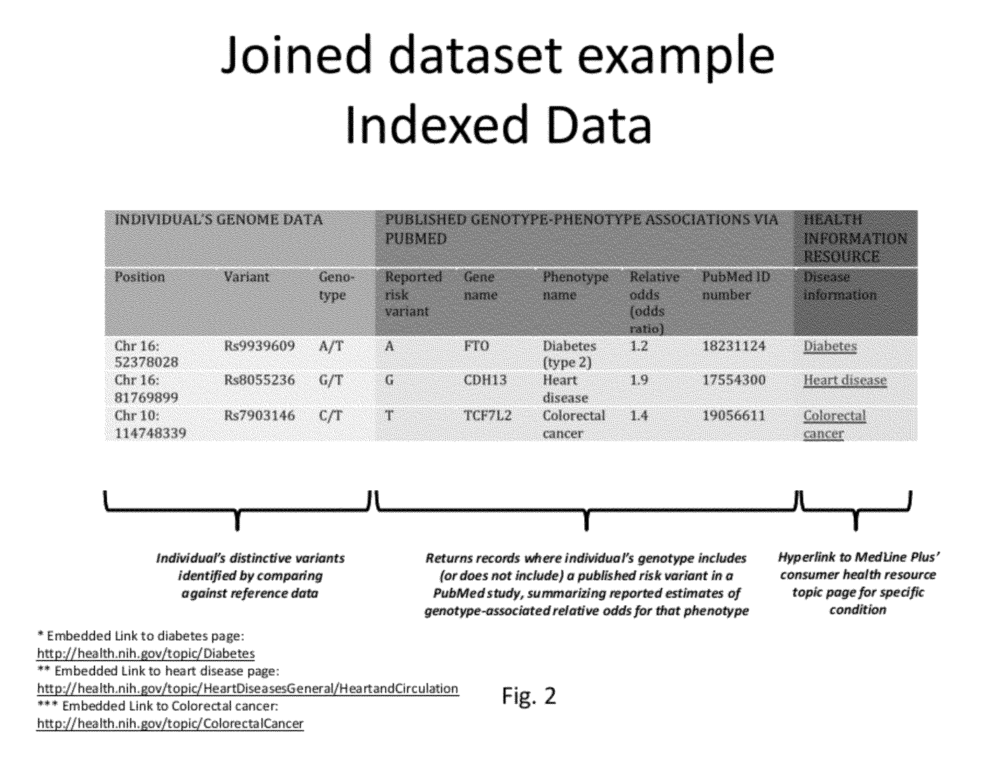

The present invention links data from dataset E to another database that has consumer health information about the identified phenotype, disease, condition, symptom, etc. This database is referred to herein as phenotypic database F. An example of such an online phenotypic database is MedLinePlus, a government supported health information resource. MedlinePlus can be found at the following link: http://www.nlm.nih.gov/medlineplus/. Any phenotypic or health information database that contains information about the phenotypic condition can be used, including those known or later developed. Other examples of publically available online disease or phenotypic databases include Mayo Clinic, Google Health, Wikipedia, WebMD and the like. The software, using dataset E, identifies the phenotypic condition, and compares the phenotypic condition with that in phenotypic database F to obtain a reference, identification or hyperlink to information publicly available for the phenotypic condition. In an example, as shown in FIG. 1 as a MedLine Plus “annotation”, a research study that linked a specific genetic variant to heart disease is found in an individual (dataset E), and so this linked database would also include a hyperlink (e.g., an embedded link) in the generated output to the MedLinePlus webpage for heart disease. The consumer health information include links to articles and publications regarding identified phenotypic conditions found from one or more of consumer oriented health information repositories. Consumer health information, such as MedLinePlus, can include links as well as actual data (e.g., documents, pictures, audio files, video files, and the like) that are meant to describe health information to the general public. This comparison of the phenotypic condition of dataset E to database F to obtain a reference or link is also done using a computer with a processor and processor routine. This could be done by using a “search” function in MedLinePlus or other NIH health resource, where hyperlink would direct to top “topic” search result (i.e.: database would include hyperlink to health.nih.gov/topic/######, where ##### is the standardized phenotype associated contained within the PubMed record (see the hyperlink in FIG. 2). Any misclassification of a phenotype to a MedLine resource either through data entry error, language standardization error or comprehension error can be minimized or reduced by using standardized medical terms through resources like ULMS. Undefined or mismatched terms would automatically be flagged for review or exclusion.

The present invention further includes providing indexed or joined dataset G which includes the filtered hits from database E combined with the link to information about the phenotypic condition from database F (e.g., MedLine Plus database). In an embodiment, the joined dataset includes a match between the individual's genetic variant information, PubMed (e.g., journal or research) information including genotypic variant information and the associated phenotypic condition, and a MedlinePlus (e.g., consumer health information) identifier/link to information about the phenotypic condition. The joined dataset, which is stored in a database, can be generated to an output device. An “output device” is defined as a medium for communicating the information and includes e.g., printouts, monitors showing screen outputs on computers or hand held/mobile devices, email output, and the like. Output devices include any device that allows for access to the joined dataset described herein or an interactive genome browsing tool. Output devices include those that are known in the art and those that are later developed. In another embodiment, a genome browsing tool can be downloaded to a computer, mobile phone, PDA or other device to view the generated output described herein.

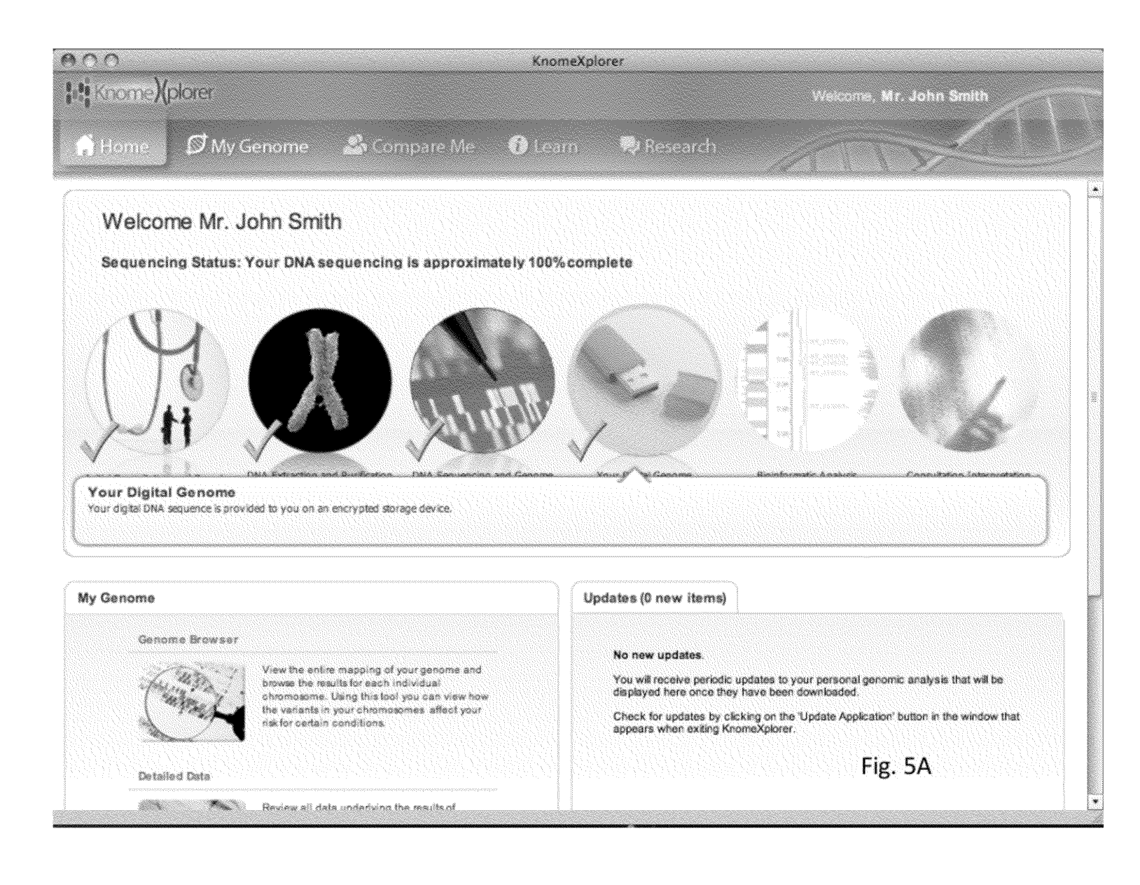

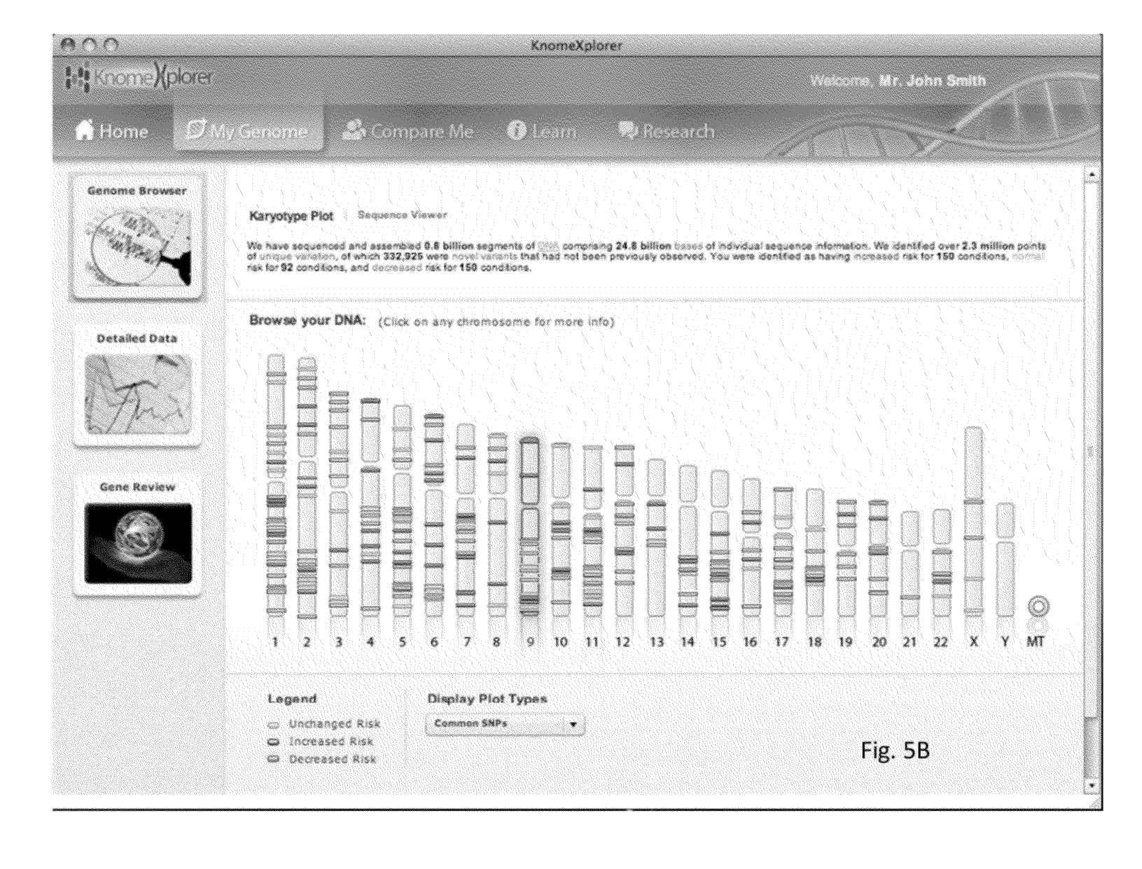

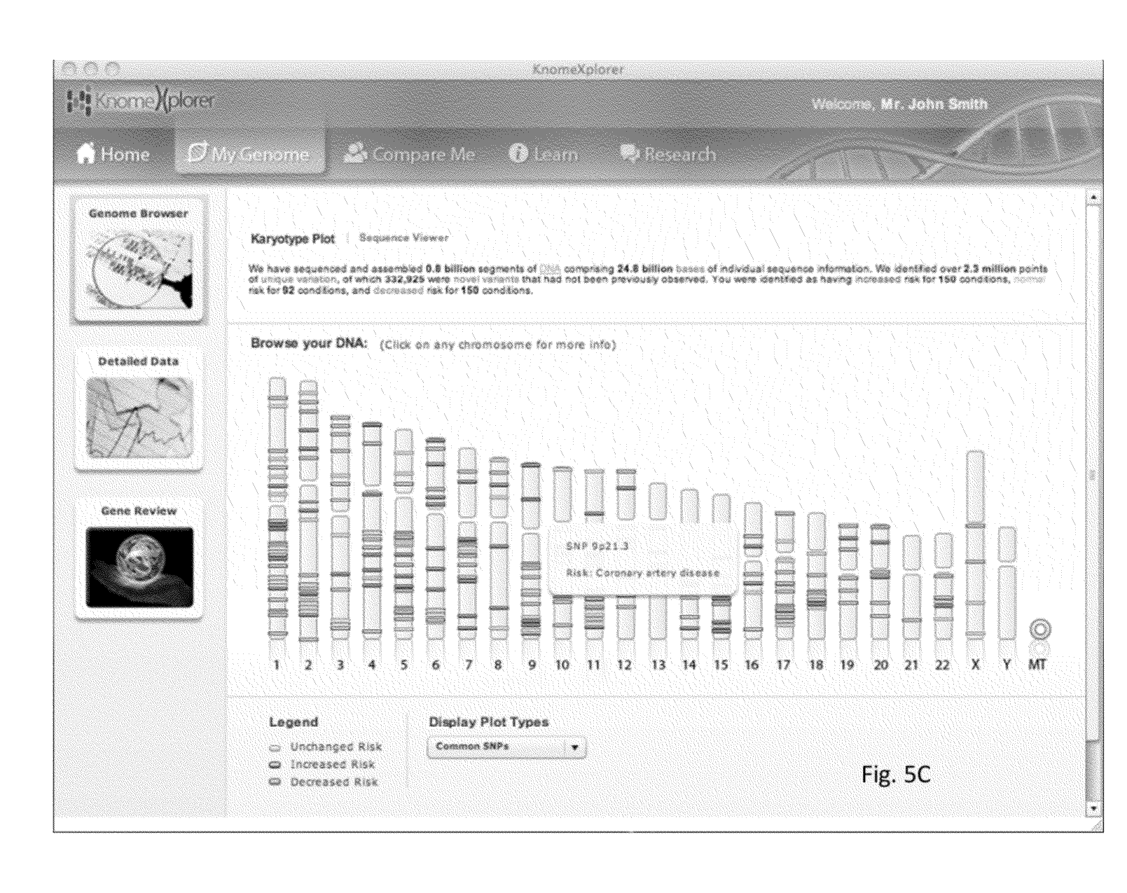

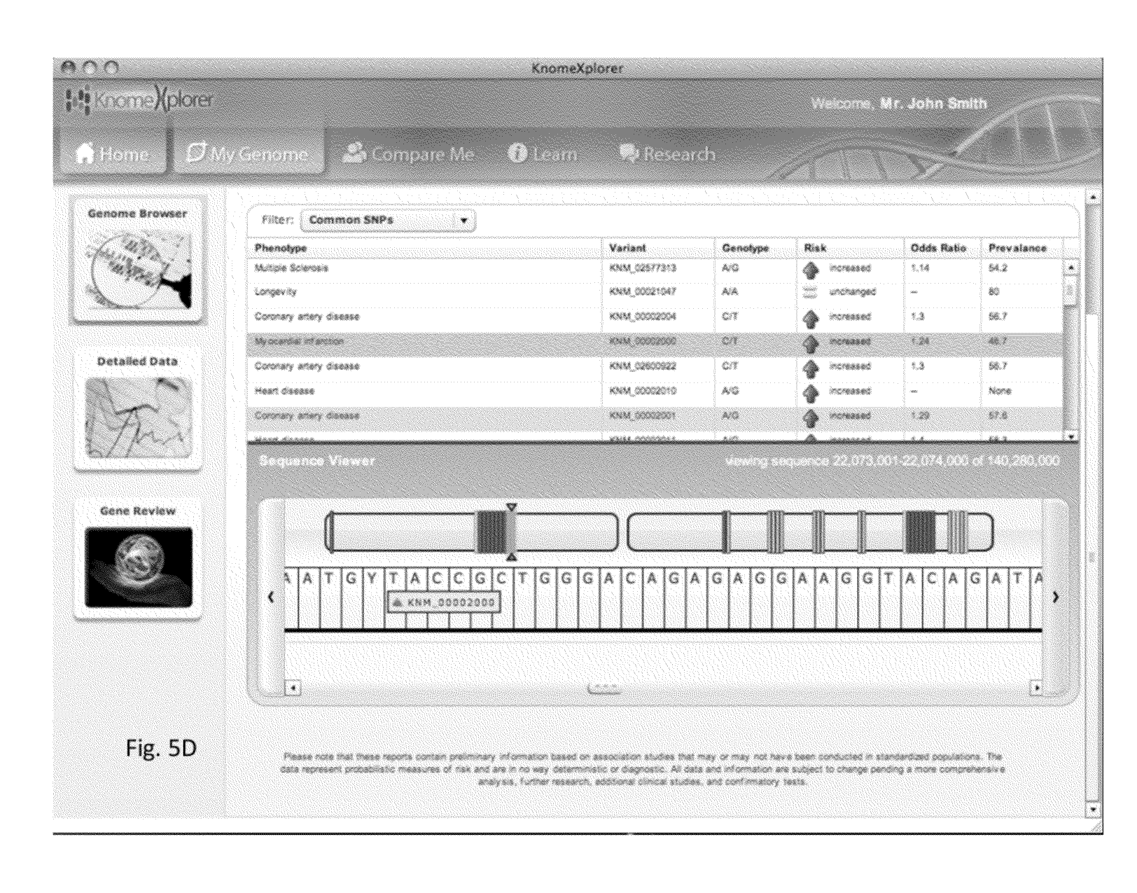

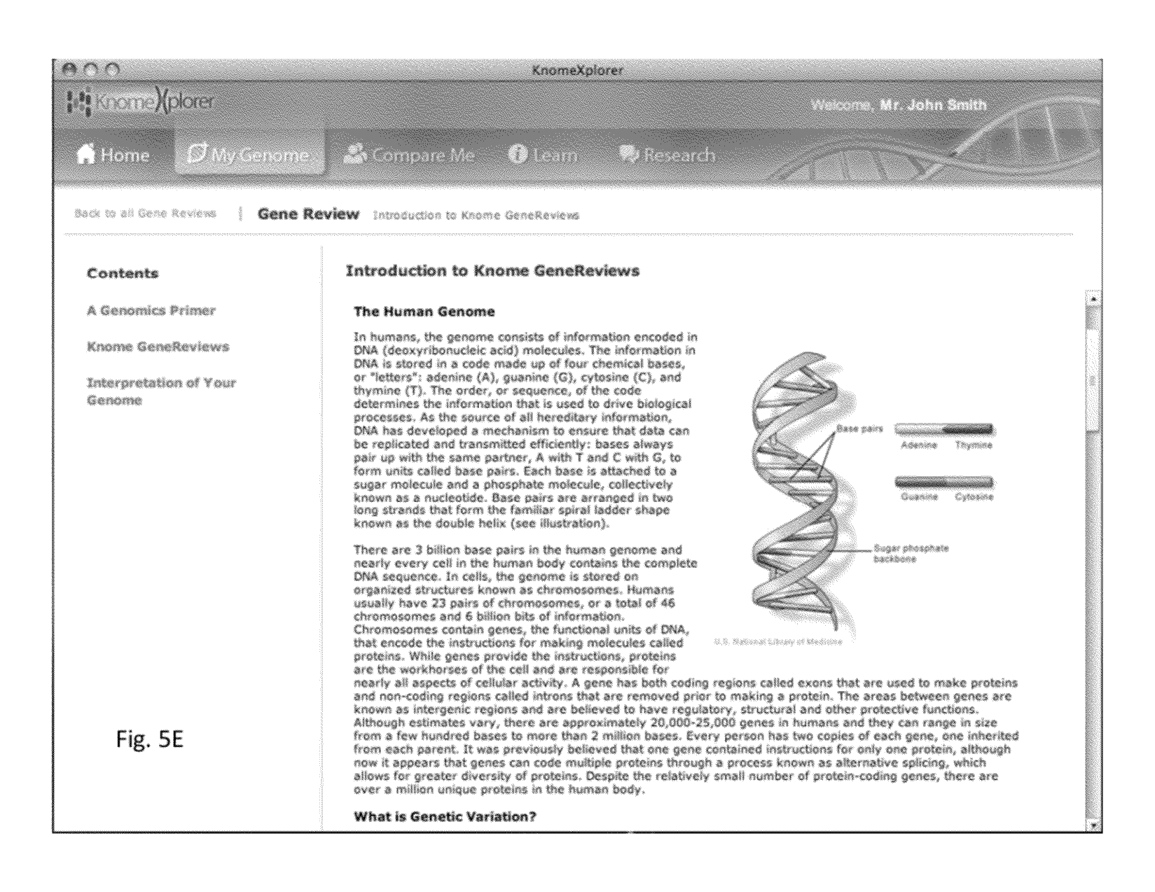

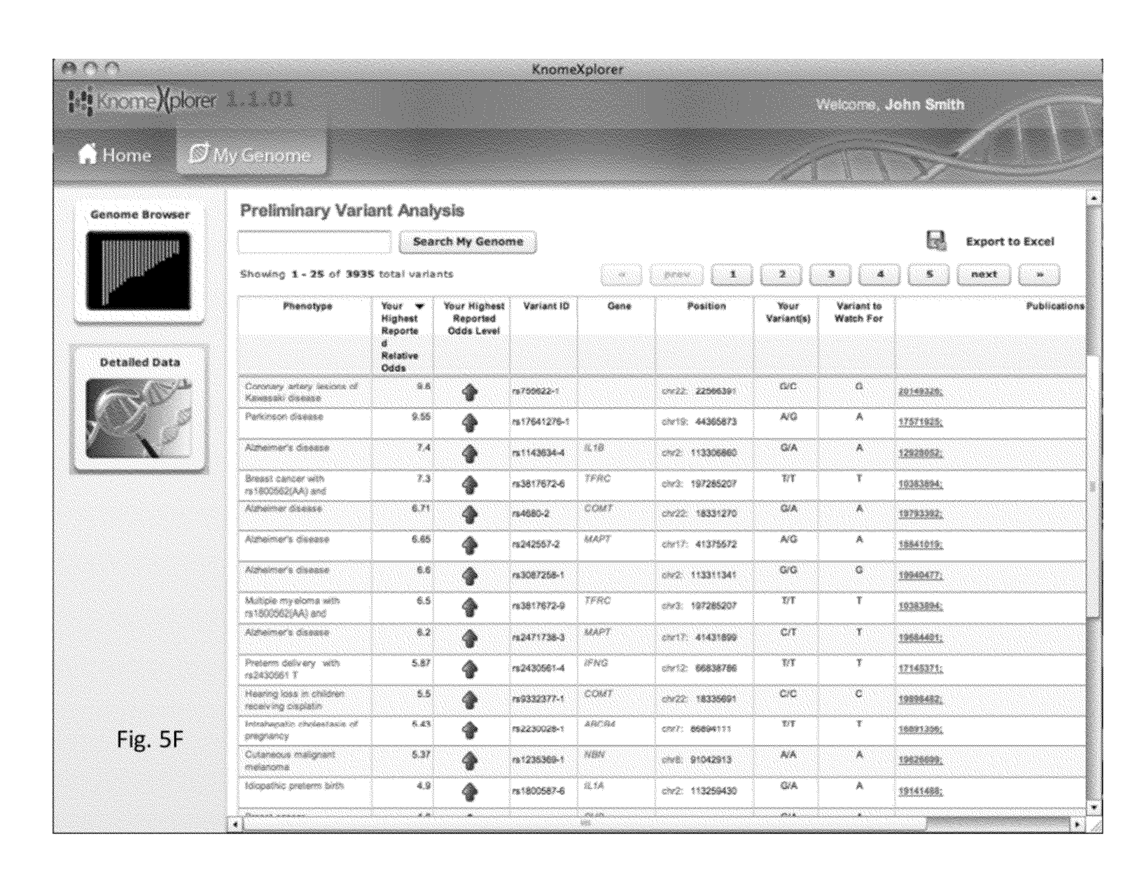

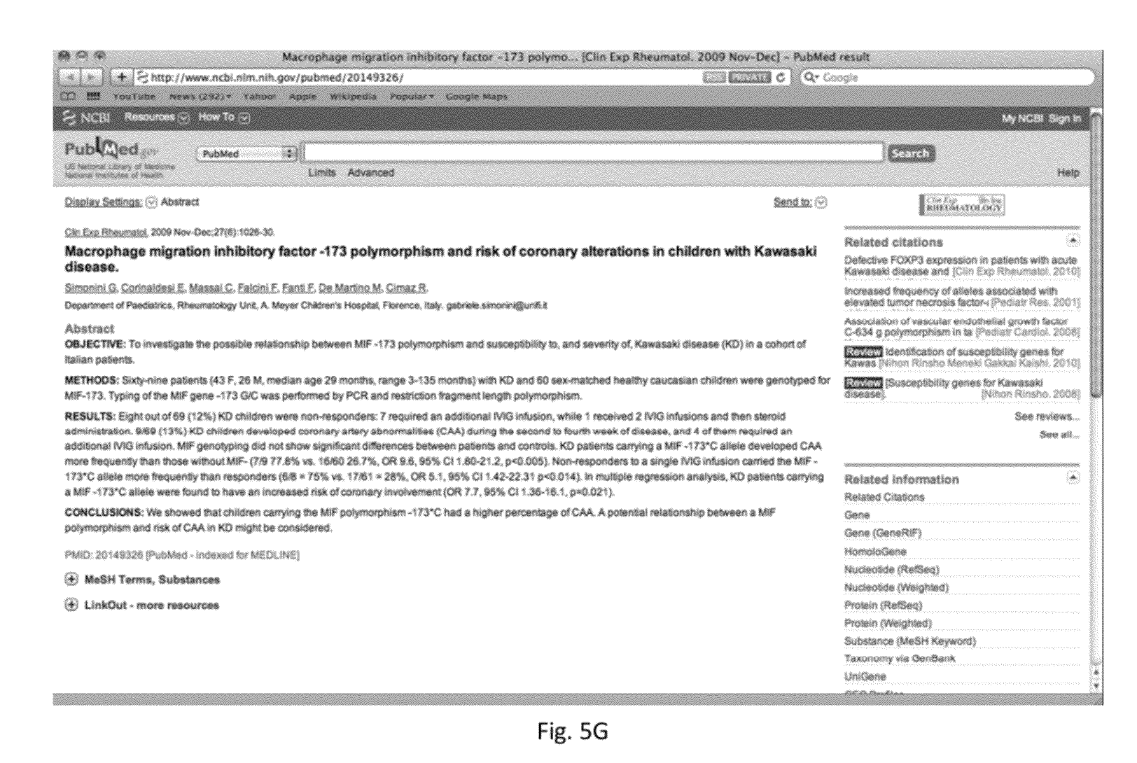

In a preferred embodiment, the output is an interactive screen generated browsing tool such as browsing tool H. Browsing tool H includes, in an aspect, a list of records that can be viewed in table form that highlights variants in an individual's genome that have been studied (via PubMed) with links out to a trustworthy consumer health resource (like MedLinePlus). See FIG. 2. In another aspect, as shown in FIG. 5, further described herein, the output can be viewed graphically via a genome browser (e.g., geographical representations of gene and variant alleles can be presented with links and information to data described herein). The variants associated with a hit from the filtered data can be color coded or otherwise displayed visually (e.g., with a symbol) to indicate the type of risk the journal reference reports from the PubMed database as linked to the individuals genomic variant information.

An example of a typical record in joined dataset G would contain the union of the following data sets, where there has been a “match” or “hit” across all three sources of information: individual genotype and/or variant information (e.g., one or more variants), genotype-specific phenotype association (e.g., PubMed), and disease information (e.g., MedlinePlus). As shown in FIG. 2, individual genetic information includes e.g., specific position/coordinate, unique variant identifier (rs#) and genetic variant/genotype at the specific position. This information is linked by the variant match to genotype-phenotype association (e.g., from PubMed), as described herein. Genotype-phenotype information includes genetic variant associated with specific phenotype, the gene name, phenotype name, relative odds measure (usually in the form of an odds ratio or other statistical measure identified by a journal reference), and PubMed ID number, to allow a direct audit trail back to the original source of the information. This data is further linked by a phenotypic match to health information resource (from MedLinePlus, or similar database). The health information resource, in an embodiment, is a hyperlink or identifier to the relevant resource or topics page in MedLinePlus or similar health information resource. Additional relevant genetic and/or phenotypic information can be gathered and displayed.

In yet another embodiment, the output or information in the joined dataset G can further be compared with information from a registry of clinically validated genetic tests. Such a registry can include the type of test, the genetic variant tested, the associated phenotype of the variant, etc. Such genetic testing registries can, in an embodiment, collect information from providers including evidence of accuracy and clinical usefulness of certain genetic markers and tests. The variant match, described above, can be compared to the one or more variants used in the genetic tests that reside in the registry. In the event that there is a match between the variant identified from the individual and a variant in structured database D, then the match is further compared to the variant that is the basis of the genetic test that is in the genetic testing registry. If there is a match across these databases (e.g., dataset B, structured database D and the registry database), then the present invention includes providing an output that links to such a genetic testing registry. Specifically, a link or information about the specific genetic test that forms part of the genetic test registry can be provided in an embodiment. Examples of such registries include Genetics Testing Registry (GTR) that is being developed by the National Institutes of Health (NIH). The advantage of this additional output and step is that the end user is able to obtain further information about the variant and has the option of taking this specific genetic test found in the registry. Consequently, to carry out the step, the computer apparatus or system includes a source of data of a registry of genetic testing, a processor and processor routine to perform the comparison, and an output device to provide the information or display.

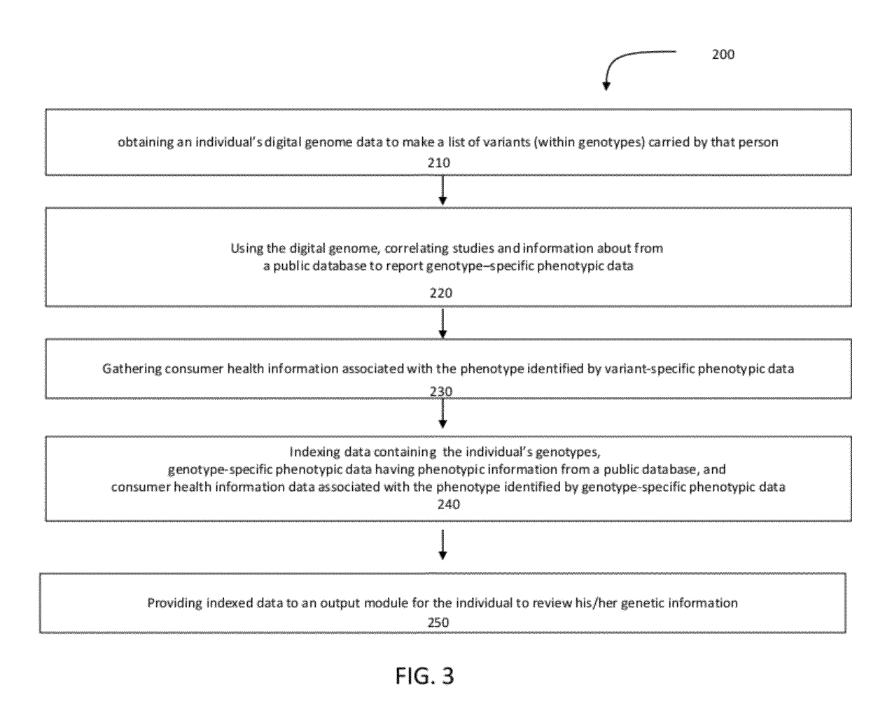

FIG. 3 is a block diagram summarizing the steps of the methods for providing indexed variant genomic data associating publically available phenotypic studies about the variant and consumer health information with phenotype. The method shown in FIG. 3 includes obtaining an individual's digital genome to make a list of variants (within genotypes) carried by an individual (step 210). A call list can include one or more “variations”, “variants”, “mutations”, “genetic markers”, “polymorphisms”, or “SNPs” and is based on a comparison of the nucleic acid sequence at the corresponding site in the individual's digital genome to a reference genome. A “variant” or “genetic variant” is a single or double mismatch of an individual genome, as compared to a reference genome.

Using the genome variation call list, a variant-specific phenotypic data set is reported or generated including studies and information associated with a (e.g., one or more) variant from the call list (step 220). The variant-specific phenotypic data contains information identifying one or more of phenotypic conditions reported in the literature and that are associated with the individual variants. The present invention includes gathering consumer health information associated with the phenotype identified by the variant-specific phenotypic data (step 230). The individual's genotype information is correlated with the genotype-specific phenotype data determined in step 220 and the consumer health information associated with the genotype-specific phenotype (step 240) to create indexed data. The indexed data includes individual's genomic data including variant information, publically available information about the variant and associated phenotypic information about variant available in studies, and consumer health information about the identified phenotype. The method includes providing the indexed data to an output module for the individual to review (step 250).

### System:

Generally, the present invention relates to a computer system or computer apparatus to carry out the methods described herein e.g., for indexing or filtering the aforementioned data, and/or providing an output of the joined dataset. In general, the system includes a source of data (e.g., databases generated or made, as described herein). A computer system of the present invention embodies a software program or processor routine to process the data by performing the indexing, filtering, and provide the generated output. The computer system employs a host processor in which the operation of software programs is executed. The software provides an output for either memory storage or to an output device.

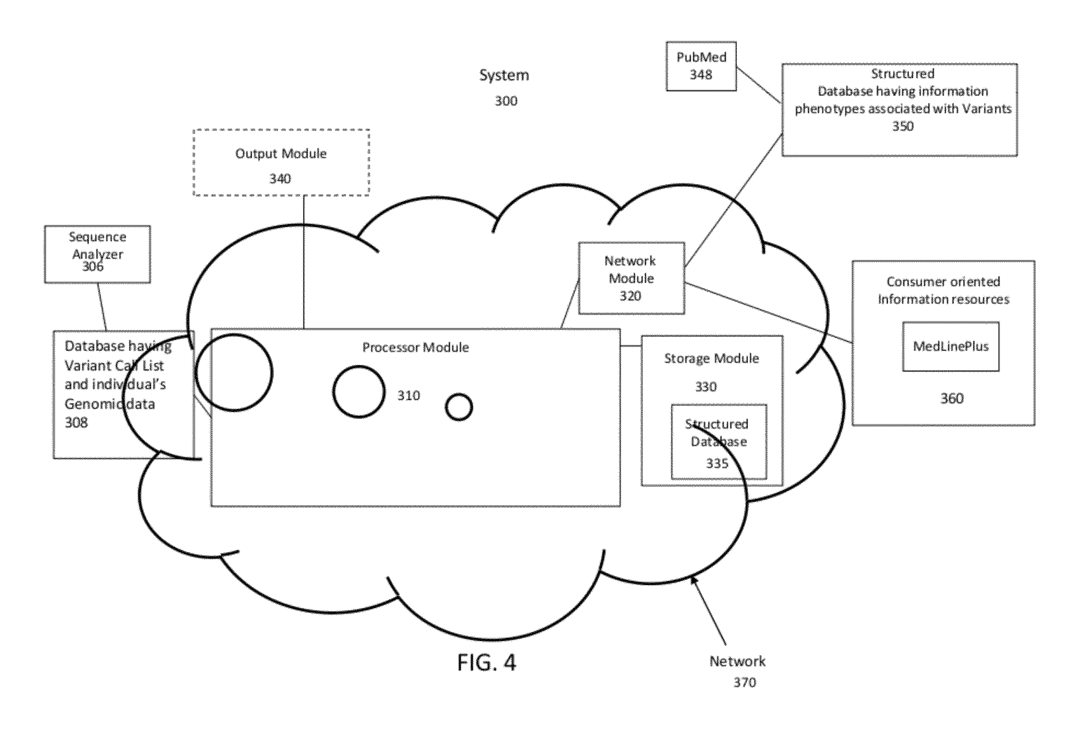

FIG. 4 is a block diagram showing an embodiment of the personal genome indexing system of the present invention. The method described in FIG. 3 can be implemented by the combination of, for example, a system 300 having a processing module 310 (e.g., a processor), a network module 320 (e.g., a network), a storage module 330 (e.g., storage), and an output module 340 (e.g., an output device or means). The system 300 utilizes various other networked components to process a variety of requests from the processing module 310. As described in further detail herein, the system 300 can be coupled to various informational sources (e.g., databases), such as structured database 308 containing individual variant genetic information, variant-associated phenotypic databases 350 derived from a Pubmed database 348, and consumer health information databases 360. Each of these couplings exists, in an embodiment, as a direct connection, or can exist as an indirect connection through network 320.

Network 370 can be any network or combination of networks that can carry data communications, and can be referred to herein as a “computer network.” Such network 370 can include, but is not limited to, a local area network, medium area network, and/or wide area network such as the internet. Network 370 can support protocols and technology including, but not limited to, World Wide Web protocols and/or services. Intermediate web servers, gateways, or other servers can be provided between components of the system 300 depending upon a particular application or environment.

Output module 340 can be implemented in software (e.g., executing a browser tool), firmware, hardware, or any combination thereof. Output module 340 can be implemented to run on any type of processing devices including, but are not limited to, a computer, workstation, distributed computing system, embedded system, stand-alone electronic device, networked device, mobile device, display device, or other type of processor or computer system. When output module 340 is implemented as a device or as software in the device connected to other components via network 370, such device implementing the output module 340 can be referred to herein as a “remote client.”

Likewise, the entire system 300 can be implemented in software, firmware, hardware, or any combination thereof. The system 300 can be implemented to run on any type of processing device including, but not limited to, a computer, workstation, distributed computing system, embedded system, stand-alone electronic device, networked device, mobile device, display device, or other type of processor or computer system.

Furthermore, system 300 can be used as a stand-alone system or in connection with a search engine, web portal, web site, or any other applications capable of presenting genomic information for review. In addition, system 300 can operate alone or in tandem with other systems, servers, or devices, and can be part of any application, databases, search engine, portal, or web site.

Functionality described herein is described with respect to components for clarity. However, this is not intended to be limiting, as functionality can be implemented on one or more components on one device or distributed across multiple devices.

The processing module 310 handles a set of routines for receiving variant call list, determining phenotypic conditions associated with the genome variations from informational sources, and generating the genotype-phenotype association data, generating phenotype data, and generating the index data. The processing module 310 obtains an individual's variant call list and the individual's digital genome from structured database 308. The digital genome is obtained from sequence analyzer 306.

In some embodiments of the present invention, the genome variation call list can be received via the network module 320. In other embodiment, the genome variation call list can be stored and retrieved from a storage medium when the storage medium is inserted or otherwise coupled with personal genome indexing system 300. Examples of storage mediums may include, but are not limited to, internal hard drives, external hard drives, flash drives, optical recording mediums (e.g., CDs, DVDs, Blue Ray discs), tapes, and the like.

In another embodiment of the present invention, the processor module 310 can generate the variants call list, locally, from the individual's variation information entered via user input devices, such as keyboard and mouse. In some embodiments, system 300 can be equipped with touch screen enabled display and on-screen key board. Using the touch screen and on-screen keyboard, the user can supply required information or the information can be obtained from database 308.

In some aspects, the individual's digital DNA sequence data and the reference DNA sequence data can be obtained from a storage medium, or from networked storage locations containing such data via the network module 320.

In some embodiments of the present invention, the reference human DNA data can be obtained from online database, such as genome reference consortium (e.g. the Reference Human Genome, NCBI Build 36, www.ncbi.nlm.nih.gov/projects/genome/assembly/grc/human/index.shtml). In another embodiment, the digital reference DNA sequence data can be obtained from a networked storage location. Moreover, the digital reference DNA sequence data can be stored in a storage module 330, and can be updated manually, periodically or when a newer version of reference DNA sequence data is available.

When the individual's digital DNA sequence data and the reference DNA sequence data are compared e.g., by processor module 310, the differences between the reference genome and an individual's genome are recorded in a predetermined data format, and stored in a storage medium, which is accessible to the system 300. In another embodiment, the variant call list and the individual digital genome can also be stored in the storage module 330, or other networked storage locations.

The system relates to a structured database 350 having phenotypic information associated with genetic variants or genotypes and is derived from a database storing research and journal article information (e.g., Pubmed Database 348). In a preferred embodiment, structured database 350 with cites to papers and journals about genetic variant information and its associated phenotype is developed and annotated. In another embodiment, the information of structured database 350 is obtained by generating queries and parsing information. In an embodiment, to increase the accuracy in determining the information about phenotypes associated with the variant, multiple informational sources can be used. In addition, such information in different informational sources (e.g., different types of databases) can be indexed differently, requiring different search methods. Accordingly, in some embodiments of the present invention, the processing module 310 can be coupled with a query generator which generates optimized queries for searching informational sources having studies and research about phenotypes associated with one or more genetic variants. The generated queries and the corresponding search hit results from the targeted databases can be transmitted via the network module 320. In an aspect, the processor module 310 determines the research and studies associated with the phenotype by matching the position of the variant and/or the nature of the variant (e.g., a single mismatch, or double mismatch).

There are several informational resources having phenotypic information about genetic variants available online. Accordingly, in some embodiments, the variant-specific phenotype information and cites obtained from the informational sources or extracted from the medical literatures, can be indexed and stored in a storage module, thereby forming a structured database 350. Structure database can stored independently from network 370 and communicate with network module 320 to provide the information. Additionally, the variant-specific phenotype information from medical literature database can be stored in storage module 330 along with storage database 335.

Processor module 310 utilizes the obtained variant call list and determines research information and studies associated with the variants/genotypes contained in the variant call list. Once indexed, the indexed information can be stored in database 335. The structured database 335 contains indexed information of the joined dataset. In some embodiments of the present invention, the structured database 335 and/or database 350 can be located in a centralized server or a removable storage medium. Structured database 335 includes the union of the following data sets, where there has been a “match” across all three sources of information: individual genetic information, genotype-phenotype association (e.g., PubMed), and disease information (e.g., MedlinePlus). Individual genetic datapoints includes e.g., specific position/coordinate, unique variant identifier (rs#) and genetic variant/genotype at the specific position. Genetic variant-specific-phenotype datapoints include genetic variant associated with specific phenotype, the gene name, phenotype name, relative odds measure, and PubMed/journal ID number, to allow a direct audit trail back to the original source of the information. The phenotypic consumer health datapoints include links to the resource, information about the phenotype, photos, videos and audios about the phenotype. In an embodiment, a consumer health datapoint includes a hyperlink or identifier to the relevant resource or topics page in MedLinePlus or similar health information resource. Additional relevant genetic and/or phenotypic information can be gathered, stored and/or displayed.

The variant specific phenotypic data obtained from one or more journal databases is used by the processing module 310, and the phenotypic conditions that are associated with the individual's variants are compared against data from the various consumer (i.e., general public) oriented health information repositories. Examples of such repositories (e.g., Medline Plus) or databases are described herein. In an embodiment, the processing module 310 can be set to search certain databases or a limited number of consumer health information databases.

The index data can be transferred to the output module 340. The index data can be generated in a predetermine format, such as excel, CVS, XML, HTML, or any other computer readable format. In some embodiments of the present invention, the output module 340 can be a separate device connected to the system 300 via network 370. In another embodiment, the output module 340 can be installed with software designed to display the index data. The display, in an aspect, shows a list of records that can be viewed in table form that highlights variants in an individual's genome that have been indexed. An “output module” is defined as a medium for communicating the information and includes, e.g., printers, display devices, or handheld/mobile devices, and the like. Output module 340 includes any device that allows for access to the index data described herein or software for viewing the index data (e.g., an interactive genome browsing tool). In a preferred embodiment of the present invention, the output module 340 is software implemented, and can be installed or otherwise run a computer, mobile phone, PDA or other device to generate output described herein. In an example, the output module 340 is a browsing tool installed on a user terminal, displaying an interactive screen showing the index data generated by the processing module.

FIG. 5A shows the “home screen” of the browser tool of the present invention and FIG. 5B is an illustration of an exemplary output, which can be viewed displayed through the software. As shown in FIG. 5B, the output module 240 can display graphical representations of human genome data in “karytoype” view or by chromosome. Each column represents a chromosome (23 pairs in the human genome). The display of the browsing tool shows “hits” where the individuals' genotype at a position matches a variant that has been associated with a disease, condition or trait in the scientific literature. Only “hits” or indexed data appear in the visualization. The variants associated with phenotypic conditions identified in the personalized genome dataset can be color coded or otherwise graphically highlighted (e.g., with a symbol). When the user selects the highlighted section of graphical representation of the variant, the phenotypic conditions associated with the selected variant can be presented with the scientific literatures associated with the variant as well as information or links to the consumer health resource topic page of the phenotypic condition. In particular, when the user interacts with the browsing tool and selects (e.g., mouse click, touches the screen) one of the bars, the variant and the associated disease or phenotype condition information is provided (e.g., pop-up window) as shown in FIG. 5C. Alternate view can be displayed when the user selects one of the chromosomes.

In FIG. 5D shows an enlarged chromosome view of the selected variants. The upper half of the view shows associated phenotypes and other related information, such as variant, genotype, risk category, odds ratio, and prevalence. The bottom half of the screen shows an enlarged view of the chromosome with the actual genome sequence below in the (A's, C's, T's, G's) and the position of the selected variant appearing in the rectangular flag at the bottom of the screen. Consumer-friendly contents can be displayed when the user selects a phenotype condition as shown in FIG. 5E.

The browsing tool can also provide a table view of the index data as illustrated in FIG. 5F. Each row represents the individual's variant that is determined to be associated with a phenotype. In this view, the individual's phenotype as well as other information like, relative odds, highest reported odds level, variant ID, gene, chromosome position, the individual's variants, and the variants reported to be associated with the phenotype are provided. Furthermore, the identifiers of the genotype-phenotype information (e.g., publication that genotype-phenotype association is based on) are also displayed with hyperlink out to the abstract of the medical journal or publication. Specifically, the column on the far right is “Publication” which includes a hyperlink out to the scientific or clinical publication abstract that identified the association between the variant and a phenotype and supports the inclusion of the variant in the table. FIG. 5G is a screen display when a user clicks on the “Publication” button shown in FIG. 5F. FIG. 5G shows an abstract view from PubMed in which the variant is associated with the phenotype. Note that the abstract number in the browser's address bar matches the number in the first row under the “publications” column in screen 5 (#: 20149326).

The relevant teachings of all the references, patents and/or patent applications cited herein are incorporated herein by reference in their entirety.

While this invention has been particularly shown and described with references to preferred embodiments thereof, it will be understood by those skilled in the art that various changes in form and details may be made therein without departing from the scope of the invention encompassed by the appended claims.

What is claimed is:

1) In a computer system, a method of providing a personal genomics indexer having individual genomic information, genotypic and phenotypic information based on scientific research, and consumer health information, wherein an individual's genomic information comprises a digital genome and variant call list having one or more genetic variants, the method comprises the steps of:
a) using a processor, comparing one or more genetic variants from the variant call list from the individual's genomic information to datapoints from a database, wherein the datapoints of the database comprise one or more variant information associated with a phenotypic condition reported in a research paper or a journal article, the phenotypic condition, a relative odds measure or statistical risk associated with the variant, and an identifier of the journal article; to thereby obtain a variant match and a phenotypic condition associated with the match; and
b) using a processor, comparing the phenotypic condition associated with the match with one or more phenotypic conditions in a consumer health information database, wherein the consumer health information database comprises information or a link to information about the phenotypic condition; to thereby obtain a joined dataset comprising the individual's digital genome, the variant match, the phenotypic condition associated with the match, the identifier of the journal article, and information or the link to information about the phenotypic condition in the consumer health information database.

2) The method of claim 1, further including providing an output that provides data from the joined dataset that comprises the individual's digital genome, the variant match, the phenotypic condition associated with the match, the identifier of the journal article, and the link to information about the phenotypic condition in the consumer health information database.

3) The method of claim 2, wherein the output further includes the genetic variant of the individual, the chromosomal position of the variant in the individual, the genotype of the variant of the individual, the match, a gene name associated with the match, the phenotypic conditions associated with the match, the statistical risk reported in the journal article, the identifier of the journal article, and the link to information about the phenotypic condition in the consumer health information database.

4) The method of claim 3, wherein the output is represented in table form or graphically.

5) The method of claim 1, wherein the structured database comprises data from a publically available database.

6) The method of claim 5, wherein the structured database comprises data from the PubMed database.

7) The method of claim 1, wherein the consumer health information database comprises links to information about the phenotypic condition in a publically available database.

8) The method of claim 7, wherein the consumer health information database comprises links to information about the phenotypic condition in the MedLinePlus database.

9) The method of claim 1, wherein the individual's variant call list is obtained by comparing the individual's digital genome to a reference genome.

10) In a computer system, a method of providing a personal genomics indexed output having individual genomic information, genotypic and phenotypic information based on scientific research, and consumer health information, wherein an individual's genomic information comprises a digital genome and variant call list having one or more genetic variants, the method comprises the steps of:
a) using a processor, comparing one or more genetic variants from the variant call list from the individual's genomic information to genotypic and phenotypic information based on scientific research having information about the one or more genetic variants and associated phenotype; to thereby obtain a variant match and a phenotypic condition associated with the match;
b) using a processor, comparing the phenotypic condition associated with the variant match with one or more phenotypic conditions in a consumer health information database, to thereby obtain information or a link to information about the phenotypic condition in the consumer health information database; and
c) using a browsing tool, providing an output having the individual's genomic information including the one or more genetic variants, one or more phenotypic conditions associated with the variant match, and information or the link to information about the phenotypic condition in the consumer health information database.

11) The method of claim 10, further comprising obtaining the individual's genomic information comprising the digital genome and variant call list having one or more genetic variants.

12) The method of claim 11, where the step of obtaining the individual's genomic information comprises:
a) comparing the individual's digital DNA sequence to a reference DNA sequence; and
b) generating the variant call list, wherein the variant call list contains one or more variants.

13) The method of claim 12, wherein the personal genome data is obtained from a remote user client via a network.

14) The method of claim 10, further comprising storing in a database information selected from the group consisting of: the individual's genomic information comprises the digital genome and variant call list having the one or more genetic variants; genotypic and phenotypic information based on scientific research having information about the one or more genetic variants and associated phenotype; and information or a link to information about the phenotypic condition in the consumer health information database.

15) The method of claim 10, further comprising:
a) updating the database with new or additional genotypic and phenotypic information based on scientific research having information about the one or more genetic variants and associated phenotype; and
b) providing an updated output with the new or additional genotypic and phenotypic information.

16) A method of providing an output of a personal genomics indexer having individual genomic information, genotypic and phenotypic information based on scientific research, and consumer health information, the method comprises the steps of:
a) receiving the individual's genomic information that comprises a digital genome and variant call list comprising one or more variants;
b) comparing, with a processor, the variant call list from the individual's genomic information to datapoints from a structured database, wherein the datapoints of the database comprise a variant associated with a phenotypic condition reported in a journal article, the phenotypic condition, a gene name associated with the variant, a statistical risk associated with the variant, and an identifier of the journal article; to thereby obtain a variant match and a phenotypic condition associated with the match;
c) comparing, with a processor, the phenotypic condition associated with the match with one or more phenotypic conditions in a consumer health information database, wherein the consumer health information database comprises a link to information about the phenotypic condition; to thereby obtain a joined dataset comprising the individual's digital genome, the genetic variant of the individual, the chromosomal position of the variant in the individual, the genotype of the variant of the individual, the match, a gene name associated with the match, the phenotypic condition associated with the match, the statistical risk reported in the journal article, the identifier of the journal article, and the link to information about the phenotypic condition in the consumer health information database; and
d) providing an output that comprises data from the joined dataset.

17) The method of claim 16, wherein the individual's variant call list is obtained by comparing the individual's digital genome to a reference genome.

18) The method of claim 16, wherein the output is represented in table form or graphically.

19) The method of claim 16, wherein the structured database comprises data from a publically available database.

20) The method of claim 16, wherein the consumer health information database comprises links to information about the phenotypic condition in a publically available database.

21) A computer apparatus for providing a personal genomics indexer having individual genomic information, genotypic and phenotypic information based on scientific research, and consumer health information, the system comprises:
a) a first source of an individual's genomic information including a digital genome and variant call list;
b) a second source from a database, wherein the datapoints of the structured database comprise a genetic variant associated with a phenotypic condition reported in a journal article, the phenotypic condition, a statistical risk associated with the variant, and an identifier of the journal article;
c) a first processor routine coupled to receive the individual's genomic information from the first source and datapoints of the structured database from the second source, the processor routine utilized to compare the variant call list to genetic variants associated with a phenotypic condition reported in a journal article, to obtain a variant match and a phenotypic condition associated with the match; and
d) a second processor routine coupled to receive the variant match and the phenotypic condition associated with the match, the second processor routine utilized to link the phenotypic condition associated with the match with one or more phenotypic conditions in a consumer health information database, wherein the consumer health information database comprises a link to information about the phenotypic condition; to thereby obtain a joined dataset comprising the individual's digital genome, the variant match, the phenotypic condition associated with the match, the identifier of the journal article, and the link to information about the phenotypic condition in the consumer health information database.

22) The computer apparatus of claim 21, further comprising an output device that comprises a display of data from the joined dataset that comprises the individual's digital genome, the variant match, the phenotypic condition associated with the match, the identifier of the journal article, and the link to information about the phenotypic condition in the consumer health information database.

23) The computer apparatus of claim 22, wherein the display includes the genetic variant of the individual, the chromosomal position of the variant in the individual, the genotype of the variant of the individual, the match, a gene name associated with the match, the phenotypic conditions associated with the match, the statistical risk reported in the journal article, the identifier of the journal article, and the link to information about the phenotypic condition in the consumer health information database.

24) A system for providing personal genomic indexed information, the system comprise:
a) processor for comparing a personal genome data comprising a digital genome and variant call list having one or more genetic variants, a genotype-phenotype association data comprising one or more variant information associated with a phenotypic condition reported in a research paper or a journal article, a phenotype data comprising information or links to information about one or more phenotypic conditions in a consumer health information database, and an indexed data;
b) storage for storing the personal genome data, the genotype-phenotype association data, the phenotype data, and the indexed data;
c) a network for managing communication between a plurality of networked components including the processor and storage; and
d) an output device for presenting the indexed data to a user.

25) The system of claim 24, wherein the storage is contained in a centralized server for storing and retrieving data via network.

26) The system of claim 24, further comprising one or more of interface modules for connecting one or more removable storage devices.

27) The system of claim 24, wherein the output is a remote user terminal connected via the network.

28) The system of claim 24, wherein the output is implemented as software in a browser tool.
